(19) United States
(12) Patent Application Publication
(10) Pub. No.: US 2015/0206052 A1
(43) Pub. Date: Jul. 23, 2015

(54) ANALYSIS OF MEDICAL EQUIPMENT USAGE

(71) Applicant: medlint Holdings, LLC, King of Prussia, PA (US)

(72) Inventors: John Heil, Malvern, PA (US); James Armbruster, Schwenksville, PA (US); Tina Laskowski, West Chester, PA (US); Cary Connor, Havertown, PA (US); Robert Marino, Havertown, PA (US); Gary Hardel, Wayne, PA (US); David Steigerwalt, Mertztown, PA (US)

(73) Assignee: medint Holdings, LLC, King of Prussia, PA (US)

(21) Appl. No.: 14/159,431

(22) Filed: Jan. 20, 2014

(51) Int. Cl. G06N 5/02; G06F 19/00

(52) U.S. Cl. CPC G06N 5/02; G06F 19/325

(57) ABSTRACT

For medical devices that apply radiation or other energy to patients, the way in which those devices are used may be analyzed to determine whether human factors are contributing to unnecessary doses of radiation, or to unnecessary wear-and-tear on the equipment. Medical equipment that applies energy to patients may leave a log, indicating who was operating the equipment and what protocols were used during the operation. The facility that owns the equipment may also have records, such as billing records or other institutional records. The equipment's logs, as well as the facility's records, may be analyzed in order to determine whether judgment of the technicians operating the equipment, or the physicians on whose orders the equipment is operated, are contributing to higher doses of radiation than necessary. The analysis may be used for regulatory reporting, or to correct human judgment errors, or to reduce use of consumables.

### BACKGROUND

Various medical procedures involve the administration of radiation or other forms of energy to the patient. For example, many radiological diagnostic tests such as computed tomography (CT or CAT) scans, magnetic resonance imaging (MRI), X-rays, ultrasounds, etc., involve the application of energy to the patient. Other types of procedures (such as radiation therapy to shrink tumors) are therapeutic rather than diagnostic in nature, but also involve the application of energy to the patient. As a general matter, these procedures have the salutary purpose of diagnosing or treating the patient. However, radiation and other forms of energy can be damaging to the patient, so there is reason to apply the smallest amount of energy that will serve a particular medical purpose.

In some jurisdictions, regulations governing the health professions requiring analysis and/or reporting on the amount of radiation that has been administered to a patient. And apart from legal regulation, there may be economic reasons for a provider to analyze the amount of radiation or other energy that has been applied to patients.

Equipment that applies energy to patients is generally reliable in reporting how much radiation it has emitted, and there are formulas that can estimate how much of that energy has been absorbed by a patient. But equipment is operated by people, and what can vary considerably from operator to operator, or from facility to facility, is the way in which specific people operate the equipment. For a given set of circumstances (e.g., a medical test to be performed), different ways of operating the equipment may cause patients to receive, or to absorb, different amounts of energy.

### SUMMARY

For energy-emitting medical equipment, the ways in which the equipment is operated in various circumstances may be analyzed. The analysis may indicate whether the equipment is being operated in a way that allows a medical goal to be achieved with the minimal absorption of energy by patients, or if the equipment is being operated in a sub-optimal way that causes patients to absorb more energy than needed. Aberrations in the operating patterns may be detected. For example, if higher absorption rates are associated with particular operating technicians, or with particular prescribing physicians, or with particular facilities, those patterns may be detected. The information yielded by analysis may be used for regulatory reporting, or as a driver for a medical facility to improve its procedures.

Medical equipment, such as CT scanners, generally come with a set of procedures (e.g., “routine chest scan”, “trauma chest scan”, etc.), which specify factors such as the intensity of the radiation to be applied during a procedure, the number of images to be taken, the speed at which the patient is moved through the machine, etc. All of these factors affect how much radiation is applied to a patient. Thus, machines are fairly reliable in applying radiation in the way they have been instructed to do so. However, the operators of these machines generally have considerable discretion in giving instructions to the machine. For example, when a doctor orders a test such as a “chest scan”, it is usually up to the operating technician to determine which of the machine's procedures to use (or whether to modify the procedure to a custom procedure). If a doctor orders a CT chest scan, some technicians might use the “routine chest scan” procedure, while other technicians might use the “trauma chest scan” procedure (which likely administers a higher dose of radiation). In some cases, the technician might use different procedures depending on which doctor is ordering the test—e.g., if a technician knows that Dr. Jones likes especially clear pictures, he or she might order a higher dose of radiation when Dr. Jones orders a chest scan than when other doctors order the same test. These types of patterns in the way radiation is being used can be detected through analysis.

Once the use of radiation (or other energy) has been analyzed and patterns have been detected, the resulting information may be used for various purposes. The information may be used to satisfy state regulatory and reporting requirements. Or, it may be used as a basis for institutional change—e.g., a technician may be advised to use different protocols when performing a chest scan, or Dr. Jones may be advised to stop pressuring technicians for clearer images than are called for by medical protocol so that the technicians can stop administering higher doses of radiation on Dr. Jones's behalf.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example medical scenario in which the use of medical equipment may be analyzed.

FIG. 2 is a block diagram of an example analyzer.

FIG. 3 is a flow diagram of an example process of collecting data and performing an analysis.

FIG. 4 is a block diagram of example components that may be used in connection with implementations of the subject matter described herein.

### DETAILED DESCRIPTION

Various medical procedures involve the administration of radiation or other forms of energy to patients. Computed tomography (CT or CAT) scans, magnetic resonance imagining (MRI), X-rays, ultrasounds, etc., are diagnostic tests that involve applying radiation or other energy to a patient. Radiation may also be applied therapeutically to treat tumors. While there is a salutary purpose in applying radiation or other energy to a patient, the application of radiation or other energy can be harmful. It is ironic that, while radiation can be used to diagnose tissue damage and cancer, it can also cause tissue damage and cancer. Therefore, for the patient's benefit, there is reason to operate medical equipment in such a way that the amount of energy applied to the patient is just enough to achieve its medical goal. For this reason, many jurisdictions regulate the way in which radiation is applied to patients, and have reporting and accountability requirements that require medical providers to keep track of, and report, how much radiation they are applying.

Moreover, medical equipment itself is consumable: the part that produces radiation (the “bulb”) is expensive and is subject to wear with use. Therefore, apart from the patient's interest in reducing exposure to radiation, a medical facility may have a financial interest in reducing the application of energy to the patient.

Machines that apply radiation or other energy to patients are able to keep track of how much radiation they have emitted. Moreover, there are existing models that can be used to determine how much radiation has been absorbed by patients as a function of factors such as the amount of radiation emitted, the patient's weight, the type of radiation used, etc. Therefore, it is possible to obtain an accurate estimate of how much radiation patients in a given facility have received over some window of time. But in determining how much radiation has been applied (or is to be applied) to patients, the biggest variable is not the equipment but rather the people involved in the decision about how the equipment is to be operated. Typically, the technician who operates the medical equipment has considerable discretion to determine what protocol to use, and—therefore—how much radiation is applied to a patient.

For example, a physician might order a CT chest scan. CT scan equipment is driven by software that generally comes with various protocols. One such protocol might be a “routine chest scan”, and another might be a “trauma chest scan.” It might be the case that the trauma chest scan is intended to get a clearer picture, which involves applying more radiation during the scan. The protocols, however, do not necessarily correspond to particular orders that doctors give—e.g., a doctor might order a “chest scan”, and it might be up to the radiology technician to decide whether to use the “routine chest scan” or “trauma chest scan” protocol to carry out the doctor's order. In an egregious case, a particular technician might just use “full body scan” in every case. In this way, for a given set of circumstances (e.g., an order for a chest scan), there can be considerable variability among technicians as to how much radiation is being applied to the patient. While this example might make it appear as if all variability introduced by human factors is due to the technicians themselves, this is not the case. In a given hospital, it might be known that Dr. Jones likes exceptionally clear pictures, so the technicians might know that when Dr. Jones orders a scan they should perform the scan using higher levels of radiation than normal medical protocols call for. In this case, it is Dr. Jones, not the technicians, who are causing unusually high levels of radiation to be applied.

The subject matter herein may be used to analyze use patterns in medical equipment. The analysis may be used to comply with legal regulatory and reporting requirements. Or, the analysis may be used for institutional improvement, where an institution uses the analysis to identify and address existing problems or aberrations in the way its equipment is being used.

The analysis is performed using data from the equipment, as well as other medical and billing data that may be available. Typically, medical equipment that produces radiation creates a log of its activities. The log may show the particular protocol that was used (e.g., “routine chest scan”), any modifications to that protocol that were made (e.g., a change in speed, or an increase in the intensity of the radiation, etc.), the identity of the technician who was operating the equipment, any recorded details about the patient (e.g., the patient's height, weight, gender, etc.). The record of these logs may be provided to an analyzer. Other types of information may also be provided to the analyzer, such as billing records, or the medical provider's own records of medical procedures that have been ordered.

The analyzer may then identify various patterns in the data. For example, if, over a large sample of data, the average amount of radiation administered by technician A is higher than the amount administered by technician B (or higher than the amount administered by the overall group of technicians), the analyzer may detect this pattern. Or, if higher doses of radiation tend to be administered when carrying out the orders of one particular doctor (as compared with doctors as a whole), this pattern may be detected. Or, if the equipment's records show a much higher number of full body scans than the medical facility has billed for, this pattern may also be detected. The analyzer may prepare a report containing its findings.

Various things may be done with the findings. In one example, the report prepared by the analyzer is used for regulatory compliance—e.g., to satisfy a regulatory requirement that a medical provider report on its administration of radiation. In another example, the report may be used for improvement of a facility's practices. For example, if the report shows that technicians A and B operate the same equipment but technician A administers more radiation per patient, on average, than technician B, the facility may investigate technician A's operating practices. It may turn out that technician A is operating the equipment under different circumstances (e.g., technician A might work at night when there are more traumas, thereby causing more high-intensity scans to be performed on technician A's shift). Or, it may turn out that technician A is not following proper procedures and is irradiating patients too heavily, thereby exposing patients to unnecessary doses of radiation and wearing out the facility's equipment too quickly. In this case, technician A's practices can be corrected. Some patterns reveal correctible problems and others do not. The analysis provides information from which a medical facility can become aware of patterns in the usage of its equipment.

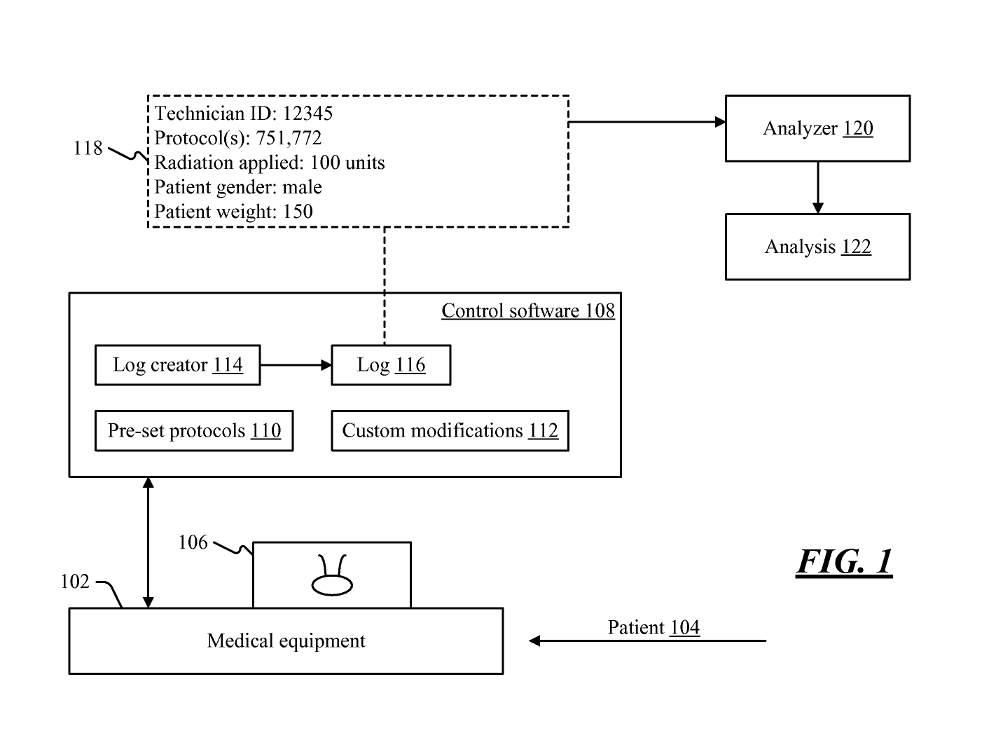

Turning now to the drawings, FIG. 1 shows an example medical scenario in which the use of medical equipment may be analyzed. Equipment 102 is a medical device that applies energy to patient 104. Equipment 102 may be a CT scanner, an MRI scanner, an X-ray machine, an ultrasound machine, or any other type of medical equipment that applies radiation or other energy to a person. Equipment 102 may have a bulb 106 (or an analogous piece of hardware) that converts electricity into the type of energy that is to be applied. One example feature of bulb 106 is that it may be consumable—an aspect whose significance is discussed below.

Equipment 102 may comprise, or may make use of, control software 108. Control software 108 controls the operation of equipment 102 while equipment 102 is being used on patient 104. For example, control software 108 may control the intensity and duration of radiation that is applied to patient 104, and may control the number and type of images of patient 104 that are captured while radiation is being applied. Additionally, certain types of equipment may have mechanical moving parts—e.g., a motorized table that moves patient into various positions while radiation is being applied—and control software 108 may control the movement of that table. In general, control software 108 may control any aspect of the operation of equipment 102.

Control software 108 may include a collection of pre-set protocols 110, and may also have the ability to receive and to store custom modifications 112 to those protocols. Control software 108 may use pre-set protocols 110 and modifications 112 to control the operation of equipment 102 during a procedure on a patient. Pre-set protocols 110 may have names such as “routine chest scan”, “trauma chest scan”, “full body scan”, etc. A given protocol may determine factors of operation such as the intensity with which radiation is applied, the duration over which radiation is applied, the way in which a mechanical table (on which the patient rests) moves during the procedure, the number and type of images that are captured during the procedure, etc. In essence, each protocol is a program. A modification may be either a separate program created from scratch, or may be an amendment to an existing pre-set program.

Control software 108 includes a log creator 114, which generates a log 116 of activities performed using equipment 102. For each procedure performed with equipment 102, log 116 may contain an entry 118 such as that shown. For example, log 116 may contain the identity of the technician who performed the procedure, the protocol(s) used during the procedure (which may include any pre-set protocols, and/or any modifications), the amount of radiation applied to the patient during the procedure, and various data about the patient (e.g., gender, weight, etc.). In the example shown, the technician's identity and the protocols used are represented by numbers, but those data could also be represented by names (or in any other way).

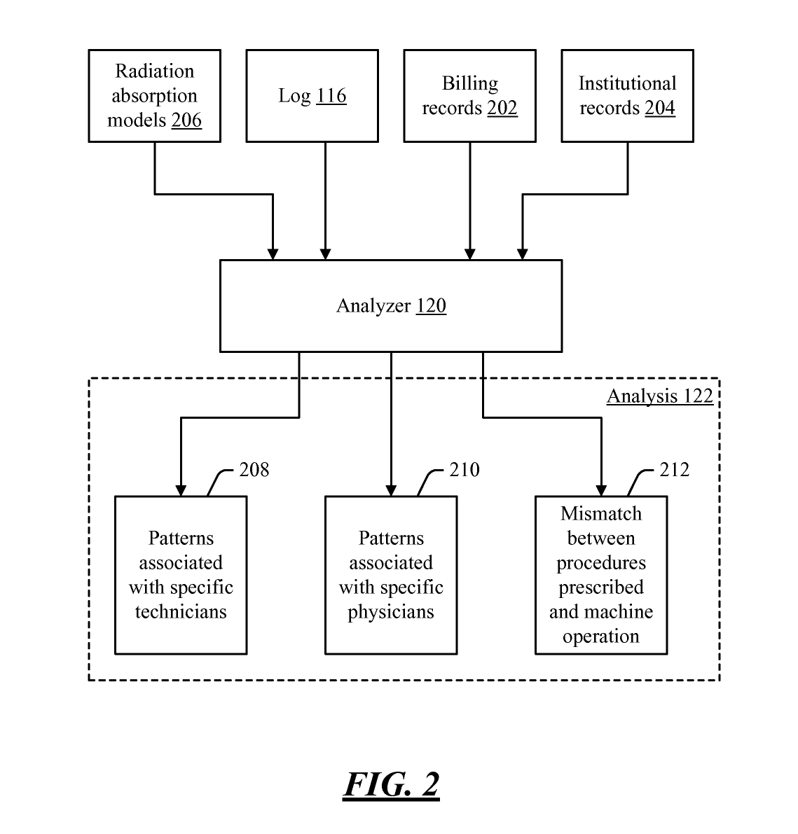

Over time, equipment 102 is operated many times and many log entries (such as entry 118) are generated. The entries from log 116 may be provided to an analyzer (along with various other pieces of information, as shown in FIG. 2 and discussed below). Analyzer 120 may create an analysis 122 of the information that is receives.

FIG. 2 shows an example of analyzer 120, and the information that analyzer 120 creates. Analyzer 120 may be implemented using hardware and/or software that is capable of receiving data and performing computations. Analyzer 120 may receive log 116, billing records 202, and institutional records 204. Log 116 may contain data concerning procedures that have been performed with equipment 102 (shown in FIG. 1), as discussed above. Billing records 202 may contain information on what procedures have been billed out by the institution (e.g., a hospital or outpatient clinic) that operates equipment 102. Institutional records 204 may be internal records generated by the institution during the course of treating patients. For example, the institution may have physicians issue orders for medical procedures through an electronic database (instead of writing out the orders by hand). In this case, the orders that have been issued may exist in electronic form, and may become part of an institution's records 204. The information mentioned above may be provided to analyzer 120, which may assist in analyzing the use of equipment 102 (shown in FIG. 1). Additionally, analyzer 120 may receive (or may otherwise have access to) radiation absorption models 206, which may be used to infer the amount of radiation absorbed by a patient. Examples of radiation absorption models include American Association of Physicians in Medicine Report 96 (AAPM-96), the International Commission on Radiological Protection Publication 103 (ICRP-103), and the report of task group 204 of the American Association of Physicians in Medicine (Size Specific Dose Estimates, or SSDE).

Analyzer 120 may use the received information to generate an analysis 122, which may comprise the following examples types of information. One type of information in analysis 122 may be detected patterns associated with particular technicians (block 208). For example, log data showing how the equipment was operated over time, and over a large number of operators, may show that the average amount of radiation applied when a particular technician operates the equipment (or absorbed by that technician's patients) is higher than when other technicians operate the same equipment.

Another type of information in analysis 122 may be detected patterns associated with particular physicians (block 210). For example, log data generated by the equipment, and prescribing data (which may be part of institutional records 204) may be analyzed to show that higher amounts of radiation are applied (or absorbed) when tests are being performed on behalf of, or on the orders of, or at the direction of, a particular physician.

Another type of information in analysis 122 may be a mismatch between procedures prescribed and machine operation (block 212). For example, if a hospital has billed for 3000 full body scans (as gleaned from billing records 202) but data show that 5000 body scans have been performed (as gleaned from log 116), this fact may suggest that technicians are performing full body scans even when a scan of less than the full body has been ordered, thereby suggesting that higher amounts of radiation than necessary are being applied to patients.

The analyses shown in FIG. 2 are merely examples. Any appropriate type of analysis 122 could be performed. Any appropriate statistical analysis technique or tool may be used to perform the analysis. For example, to detect a technician who is applying more radiation than average, the average amount of radiation applied by all technicians may be calculated, and the average amount applied by each technician may be calculated. Then a T-test or Analysis of Variance (ANOVA) test may be used to determine whether any differences between the average for a given technician and the average across all technicians is statistically significant. Other appropriate statistical analyses may be performed to detect other types of patterns.

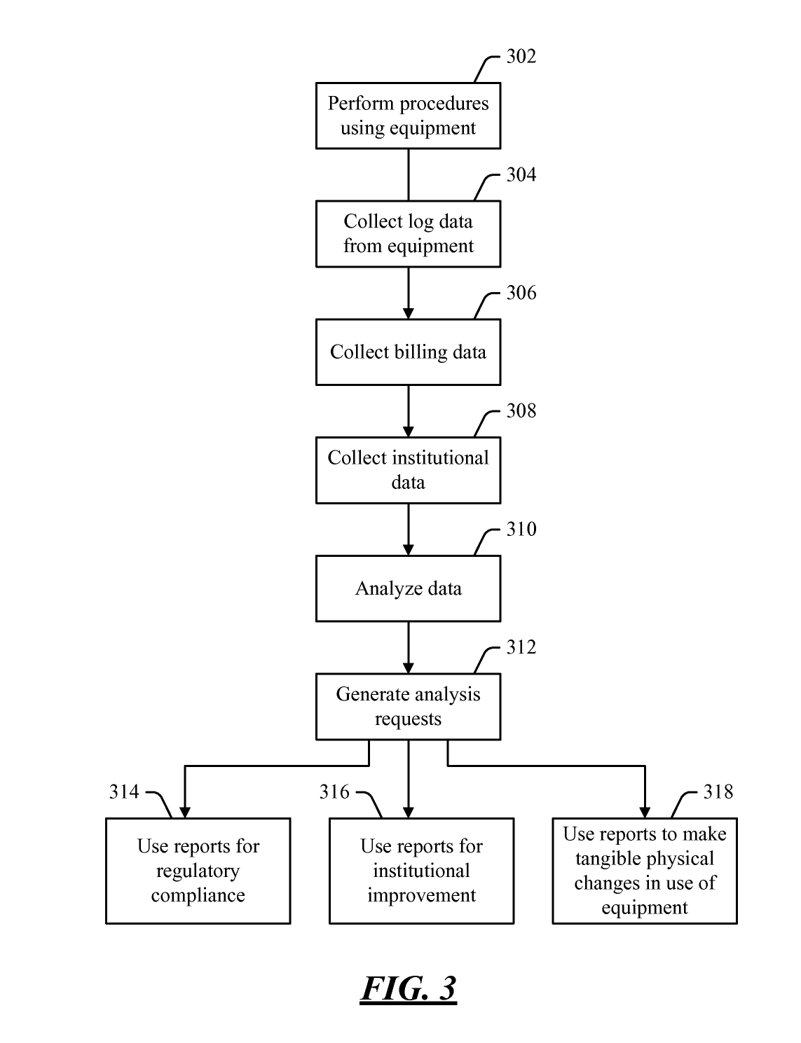

FIG. 3 shows an example process of collecting data and performing an analysis. Before turning to a description of FIG. 3, it is noted that the flow diagram of FIG. 3 is described, by way of example, with reference to components shown in FIGS. 1 and 2, although this process may be carried out in any system and is not limited to the scenarios shown in FIGS. 1 and 2. Additionally, the flow diagram in FIG. 3 shows an example in which stages of a process are carried out in a particular order, as indicated by the lines connecting the blocks, but the various stages shown in FIG. 3 can be performed in any order, or in any combination or sub-combination.

At 302, procedures are performed using medical equipment. For example, if the equipment is a CT scanner or MRI scanner, a procedure may be the act of performing a particular scan on a patient according to one or more protocols (and/or using one or more modifications of pre-set protocols). As discussed above, equipment may generate a log while it operates.

At 304, log data are collected from the equipment. At 306, billing data are collected, and at 308 institutional data are collected. As noted above, the log data may be generated by, and collected from, the equipment's control software, but the billing and institutional data may be collected from other databases maintained by the institution that operates the equipment.

At 310, the data may be analyzed. As discussed above, analysis of the data may include performing statistical tests to detect patterns and aberrations in the way that particular people operate the equipment, or in the way that the equipment is operated to carry out the orders of particular physicians, or in the way that the equipment is operated throughout the entire institution. Based on the analysis, analysis reports may be generated (at 312).

Once the reports have been generated, they may be used in various ways. In one example, the reports are used for regulatory compliance (at 314). For example, if a jurisdiction requires that a medical facility report on its use of radiation, or on instances in which the amount of radiation administered exceeds norms or standards, the reports that have been generated may be used as part of complying with that regulatory framework.

As another example, reports may be used for institutional improvement (at 316). For example, as discussed above, an analysis might reveal that a particular technician is applying more radiation on average than other technicians. Or an analysis might reveal that technicians tend to apply more radiation when the order for the procedure comes from a particular doctor (e.g., under pressure from that doctor to provide clearer pictures than normal medical protocol calls for). In either case, this analysis may provide a catalyst to discuss the problem with the technician or doctor and remedy the behavior. Of course, it might turn out to be the case that a particular technician applies more radiation than other technicians because that technician tends to work at night when more traumas occur (and trauma scans use more radiation than routine scans). So, while there could be a reasonable explanation for any aberrations detected by the analysis, the analysis provides a basis to investigate further and make any modifications to a particular person's future actions, as needed.

As another example, reports may be used as a basis to make tangible, physical changes in the use of equipment (at 318). For example, as noted above, many radiation-producing devices use a consumable “bulb” to produce the radiation, which can be expensive to replace. Thus, a technician (or physician) who causes more radiation to be applied than necessary is not only providing unnecessarily high doses of radiation to patients, but is also costing the owner of the equipment money in the form of more increase the frequency at which the bulb needs to be replaced. (It is noted that, even in the absence of a consumable component, higher doses of radiation may increase costs in the form of greater consumption of electrical energy, so reducing the use of radiation reduces the use of electricity, and therefore reduces costs.) Thus, if the report shows that certain technicians or physicians are causing more radiation to be applied than necessary, the facility that owns the equipment can direct changes in the way that the technician operates the equipment, or in the way that the physician orders certain tests, as a way of preserving the bulb (or other consumable component). It is noted that for a physical, consumable bulb (or other consumable component) to wear out is a physical transformation of matter. Therefore, a report that causes (or sets in motion) events that cause the bulb not to wear out likewise causes a physical transformation of matter, in the sense that it prevents the state change from “bulb working” to “bulb not working” that otherwise would have taken place. In short, preventing a bulb from wearing out is a physical transformation of matter.

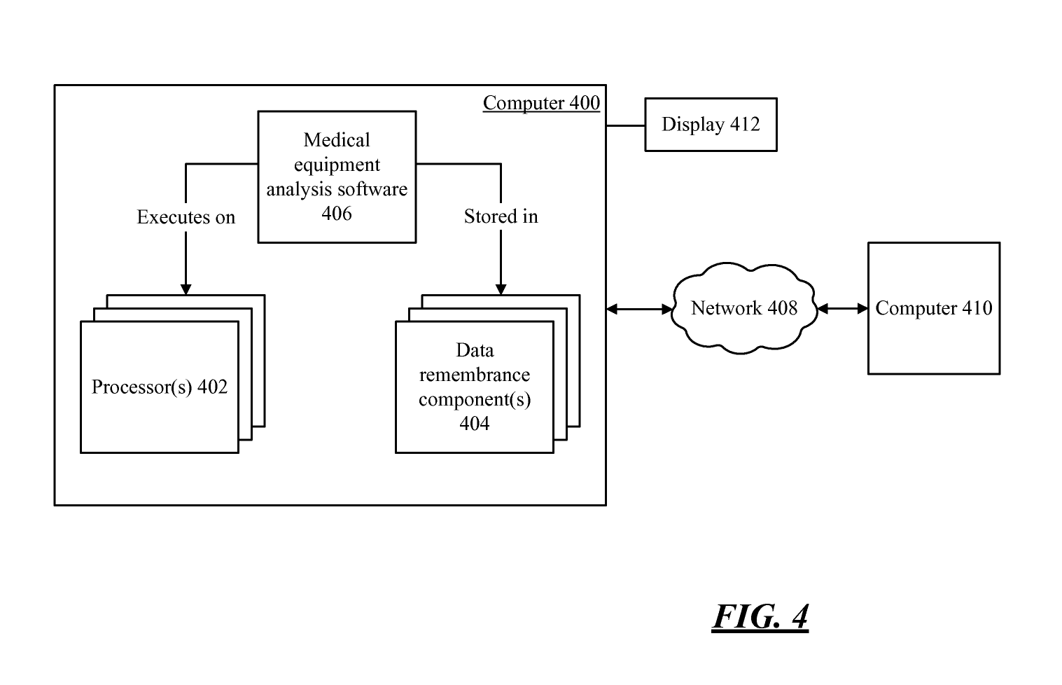

FIG. 4 shows an example environment in which aspects of the subject matter described herein may be deployed.

Computer 400 includes one or more processors 402 and one or more data remembrance components 404. Processor(s) 402 are typically microprocessors, such as those found in a personal desktop or laptop computer, a server, a handheld computer, or another kind of computing device. Data remembrance component(s) 404 are components that are capable of storing data for either the short or long term. Examples of data remembrance component(s) 404 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 400 may comprise, or be associated with, display 412, which may be a cathode ray tube (CRT) monitor, a liquid crystal display (LCD) monitor, or any other type of monitor.

Software may be stored in the data remembrance component(s) 404, and may execute on the one or more processor(s) 402. An example of such software is medical equipment analysis software 406, which may implement some or all of the functionality described above in connection with FIGS. 1-3, although any type of software could be used. Software 406 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 4, although the subject matter described herein is not limited to this example.

The subject matter described herein can be implemented as software that is stored in one or more of the data remembrance component(s) 404 and that executes on one or more of the processor(s) 402. As another example, the subject matter can be implemented as instructions that are stored on one or more computer-readable media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable media, regardless of whether all of the instructions happen to be on the same medium. The term “computer-readable media” does not include signals per se; nor does it include information that exists solely as a propagating signal. It will be understood that, if the claims herein refer to media that carry information solely in the form of a propagating signal, and not in any type of durable storage, such claims will use the terms “transitory” or “ephemeral” (e.g., “transitory computer-readable media”, or “ephemeral computer-readable media”). Unless a claim explicitly describes the media as “transitory” or “ephemeral,” such claim shall not be understood to describe information that exists solely as a propagating signal or solely as a signal per se. Additionally, it is noted that “hardware media” or “tangible media” include devices such as RAMs, ROMs, flash memories, and disks that exist in physical, tangible form; such “hardware media” or “tangible media” are not signals per se. Moreover, “storage media” are media that store information. The term “storage” is used to denote the durable retention of data. For the purpose of the subject matter herein, information that exists only in the form of propagating signals is not considered to be “durably” retained. Therefore, “storage media” include disks, RAMs, ROMs, etc., but does not include information that exists only in the form of a propagating signal because such information is not “stored.”

Additionally, any acts described herein (whether or not shown in a diagram) may be performed by a processor (e.g., one or more of processors 402) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 400 may be communicatively connected to one or more other devices through network 408. Computer 410, which may be similar in structure to computer 400, is an example of a device that can be connected to computer 400, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-readable medium having executable instructions to perform a method of analyzing use of a piece of medical equipment, the executable instructions, when executed by a computer, causing the computer to perform acts comprising:
collecting log data that represents use of said piece of medical equipment, said log data indicating protocols performed on said equipment and identifying operators of said equipment, said log data indicating amount of energy applied to, or absorbed by, patients;
analyzing said log data to detect a pattern in a way in which said piece of medical equipment is operated;
generating an analysis report indicating said pattern; and
using said report to perform an action, said action comprising complying with regulatory requirements concerning use of said piece of medical equipment, or remedying a behavior of a person who operates said piece of medical equipment or who directs how said equipment is operated.

2. The computer-readable medium of claim 1, said energy comprising radiation.

3. The computer-readable medium of claim 1, said piece of medical equipment comprising a CT scanner, an MRI scanner, or an X-ray machine.

4. The computer-readable medium of claim 1, said pattern comprising detection of a technician who operates said piece of medical equipment is applying more energy to patients than other technicians.

5. The computer-readable medium of claim 1, said pattern comprising detection that procedures performed using said piece of medical equipment apply more radiation when a physician orders procedures with said medical equipment than when other physicians order procedures with said medical equipment.

6. The computer-readable medium of claim 1, said acts further comprising:
receiving billing data from a facility that owns or operates said piece of medical equipment; and
analyzing said billing data and said log data to determine that use of said piece of medical equipment, according to said log data, does not match said billing data.

7. The computer-readable medium of claim 1, said action further comprising:
changing a physical state of said piece of medical equipment or of a consumable component of said piece of medical equipment.

8. A system for analyzing use of a piece of medical equipment, the system comprising:
a memory;
a processor; and
a first component that is stored in said memory, that executes on said processor, that collects log data that represents use of said piece of medical equipment, said log data indicating protocols performed on said equipment and identifying operators of said equipment, said log data indicating amount of energy applied to, or absorbed by, patients, said first component analyzing said log data to detect a pattern in a way in which said piece of medical equipment is operated, said first component generating an analysis report indicating said pattern, said first component using said report to perform an action, said action comprising complying with regulatory requirements concerning use of said piece of medical equipment, or remedying a behavior of a person who operates said piece of medical equipment or on whose behalf said equipment is operated.

9. The system of claim 8, said energy comprising radiation.

10. The system of claim 8, said piece of medical equipment comprising a CT scanner, an MRI scanner, or an X-ray machine.

11. The system of claim 8, said pattern comprising detection of a technician who operates said piece of medical equipment is applying more energy to patients than other technicians.

12. The system of claim 8, said pattern comprising detection that procedures performed using said piece of medical equipment apply more radiation when a physician orders procedures with said medical equipment than when other physicians order procedures with said medical equipment.

13. The system of claim 8, said first component receiving billing data from a facility that owns or operates said piece of medical equipment, said first component analyzing said billing data and said log data to determine that use of said piece of medical equipment, according to said log data, does not match said billing data.

14. The system of claim 8, said system causing a change in a physical state of said piece of medical equipment or of a consumable component of said piece of medical equipment.

15. A method of analyzing use of a piece of medical equipment, the method comprising:
using a processor to perform acts comprising:
collecting log data that represents use of said piece of medical equipment, said log data indicating protocols performed on said equipment and identifying operators of said equipment, said log data indicating amount of energy applied to, or absorbed by, patients;
analyzing said log data to detect a pattern in a way in which said piece of medical equipment is operated;
generating an analysis report indicating said pattern; and
using said report to perform an action, said action comprising complying with regulatory requirements concerning use of said piece of medical equipment, or remedying a behavior of a person who operates said piece of medical equipment or on whose behalf said equipment is operated.

16. The method of claim 15, said piece of medical equipment comprising a CT scanner, an MRI scanner, or an X-ray machine.

17. The method of claim 15, said pattern comprising detection of a technician who operates said piece of medical equipment is applying more energy to patients than other technicians.

18. The method of claim 15, said pattern comprising detection that procedures performed using said piece of medical equipment apply more radiation when a physician orders procedures with said medical equipment than when other physicians order procedures with said medical equipment.

19. The method of claim 15, said acts further comprising:
receiving billing data from a facility that owns or operates said piece of medical equipment; and
analyzing said billing data and said log data to determine that use of said piece of medical equipment, according to said log data, does not match said billing data.

20. The method of claim 15, said action further comprising:
changing a physical state of said piece of medical equipment or of a consumable component of said piece of medical equipment.
